(19) United States
(12) Patent Application Publication
(10) Pub. No.: US 2014/0160105 A1
(43) Pub. Date: Jun. 12, 2014

(54) SOURCE DRIVER

(71) Applicant: NOVATEK MICROELECTRONICS CORP., HsinChu (TW)

(72) Inventor: Li-Chun HUANG, Hsinchu City (TW)

(73) Assignee: NOVATEK MICROELECTRONICS CORP., HsinChu (TW)

(21) Appl. No.: 13/965,647

(22) Filed: Aug. 13, 2013

(30) Foreign Application Priority Data
Dec. 12, 2012 (TW) 101146972

(51) Int. Cl. G09G 3/36

(52) U.S. Cl. CPC G09G 3/3685
USPC 345/212; 345/98

(57) ABSTRACT

A source driver for driving a data line is provided. The source driver includes an output pin, a buffer amplifier, a first switch, a recycle capacitor, a second switch, a power supply circuit and a third switch. The output pin is coupled to the data line. The first switch electrically connects the buffer amplifier to the output pin in a charge period. The second switch is coupled to the recycle capacitor, and electrically connects the recycle capacitor to the output pin in a recollection period. The recollection period is after the charge period. The third switch electrically connects the recycle capacitor to the power supply circuit in a reuse period. The reuse period is after the recollection period.

This application claims the benefit of Taiwan application Serial No. 101146972, filed Dec. 12, 2012, the subject matter of which is incorporated herein by reference.

### BACKGROUND OF THE INVENTION

1. Field of the Invention

The invention relates to a source driver.

2. Description of the Related Art

A liquid crystal display (LCD), being small in size, light in weight, low in power consumption and zero radiation pollution, prevails in various information products including computer systems, mobile handsets and personal digital assistants (PDA). According to an operation principle of the LCD, liquid crystal molecules under different arrangement statuses polarize or refract light beams differently. Therefore, by controlling the light transmittance through liquid crystal molecules in different arrangement statuses, output beams in different strengths as well as red, green and blue beams in different grayscales can be generated.

The LCD respectively drives a data line and a scan line by utilizing a source driver and a gate driver to display a corresponding image. During a display process of the image, the source driver needs to constantly charge and discharge the data line, in a way that a large amount of charge is lost during the constant charge and discharge process. Especially when the LCD is applied to a mobile electronic device, the power consumption is frequently inversely proportional to a utilization period. Therefore, there is a need for a solution for enhancing power utilization efficiency.

### SUMMARY OF THE INVENTION

The invention is directed to a source driver.

A source driver for driving a data line is provided by the present invention. The source driver includes an output pin, a buffer amplifier, a first switch, a recycle capacitor, a second switch, a power supply circuit and a third switch. The output pin is coupled to the data line. The first switch electrically connects the buffer amplifier to the output pin in a charge period. The second switch is coupled to the recycle capacitor, and electrically connects the recycle capacitor to the output pin in a recollection period. The recollection period is after the charge period. The third switch electrically connects the recycle capacitor to the power supply circuit in a reuse period. The reuse period is after the recollection period.

The above and other aspects of the invention will be understood better with regard to the following detailed description of the preferred but non-limiting embodiments. The following description is made with reference to the accompanying drawings.

### BRIEF DESCRIPTION OF THE DRAWINGS

FIG. 1 is a schematic diagram of an LCD.

FIG. 2 is a schematic diagram of a source driver according to a first embodiment.

FIG. 3 is a timing diagram of a horizontal scan input signal and switch control signals according to the first embodiment.

FIG. 4 is a schematic diagram of a source driver according to a second embodiment.

FIG. 5 is a timing diagram of a horizontal scan input signal and switch control signals according to the second embodiment.

FIG. 6 is a schematic diagram of a source driver according to a third embodiment.

### DETAILED DESCRIPTION OF THE INVENTION

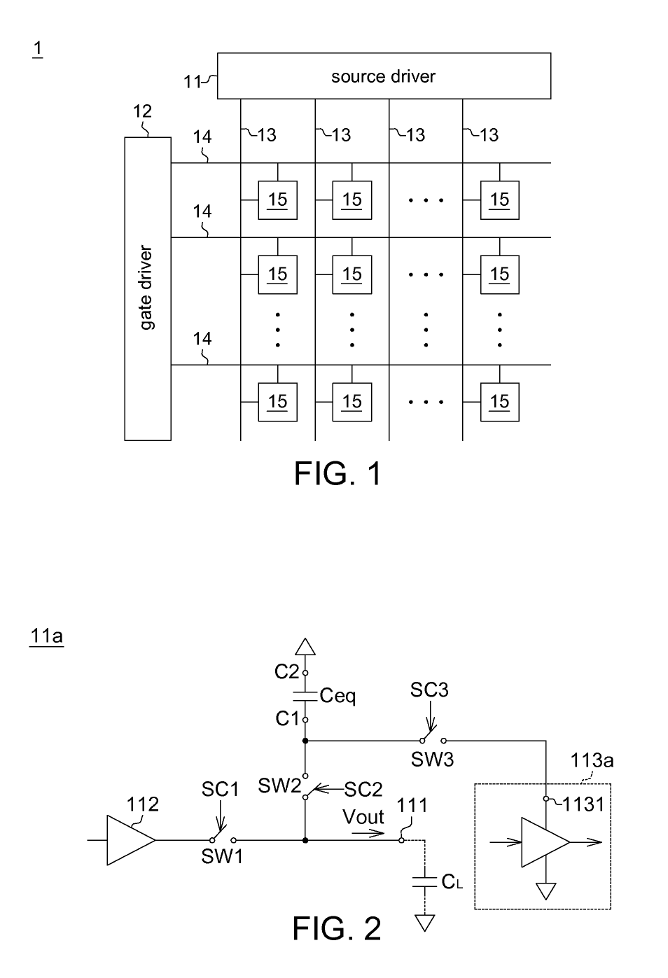

FIG. 1 shows a schematic diagram of a liquid crystal display (LCD). An LCD 1 includes a source driver 11, a gate driver 12, data lines 13, scan lines 14 and pixels 15. The data lines 13 are electrically connected to the source driver 11 and the pixels 15, and the scan lines 14 are electrically connected to the gate driver 12 and the pixels 15.

### First Embodiment

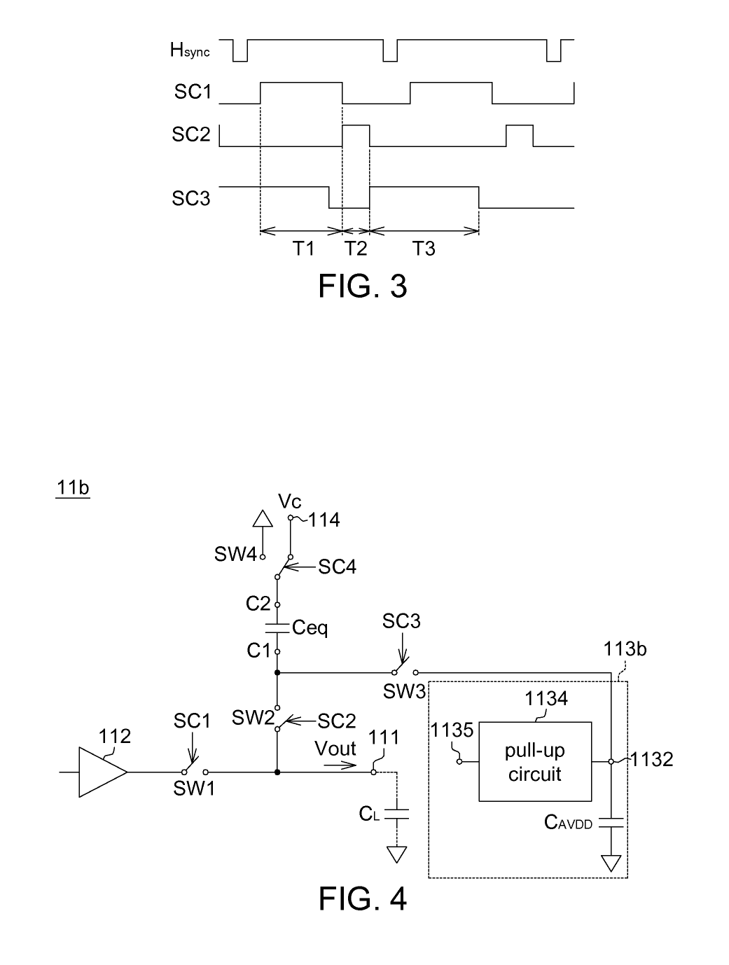

FIG. 2 shows a schematic diagram of a source driver according to a first embodiment. FIG. 3 shows a timing diagram of a horizontal scan input signal and switch control signals according to the first embodiment. The source driver 11 in FIG. 1 is exemplified by a source driver 11a in the first embodiment. Referring to FIGS. 1, 2 and 3, the source driver 11 a drives the data lines 13, and includes an output pin 111, a buffer amplifier 112, a first switch SW1, a recycle capacitor Ceq, a second switch SW2, a power supply circuit 113a and a third switch SW3. The output pin 111 is coupled to the data line 13. The second switch SW2 is coupled to the recycle capacitor Ceq. The first switch SW1, the second switch SW2 and the third switch SW3 are respectively controlled by switch control signals SC1, SC2 and SC3. Further, the switch control signal SC1 is generated after a horizontal synchronization signal H_{SYNC}.

The switch SW1 electrically connects the buffer amplifier 112 to the output pin 111 in a charge period T1. At this point, a pixel voltage Vout is outputted via the switch SW1, the output pin 111 and the data line 13 to the pixel 15. The second switch SW2 then electrically connects the recycle capacitor Ceq to the output pin 111 in a recollection period T2. It should be noted that, the output pin 111 is coupled to the pixel 15 via the data line 13. Parasitic capacitance in the source driver 11 and parasitic capacitance of the pixel 15 form a load capacitor C_{L}. When the recycle capacitor Ceq is electrically connected to the load capacitor C_{L}, the recycle capacitor Ceq recollects charge from the load capacitor C_{L}. In a following reuse period T3, the third switch SW3 electrically connects the recycle capacitor Ceq to the power supply circuit 113a. The reuse period T3 is after the recollection period T2.

Further, the recycle capacitor Ceq includes a first end C1 and a second end C2. The first end C1 is coupled to the second switch SW2, and the second end C2 receives a reference voltage. In the first embodiment, the reference voltage equals a ground level. The second switch SW2 electrically connects the first end C1 of the recycle capacitor Ceq to the output pin 111 in the recollection period T2, and the third switch SW3 electrically connects the first end C1 of the recycle capacitor Ceq to a power supply end 1131 of the power supply circuit 113a.

For example, the power supply circuit 113a is a voltage regulator, e.g., a low dropout regulator (LDO). The third switch SW3 electrically connects the recycle capacitor Ceq to the power supply end 1131 of the power supply circuit 113a in the reuse period T3. Thus, a power-saving effect is enhanced as the charge recycled by the recycle capacitor Ceq can be utilized as an operating power of the power supply circuit 113a.

### Second Embodiment

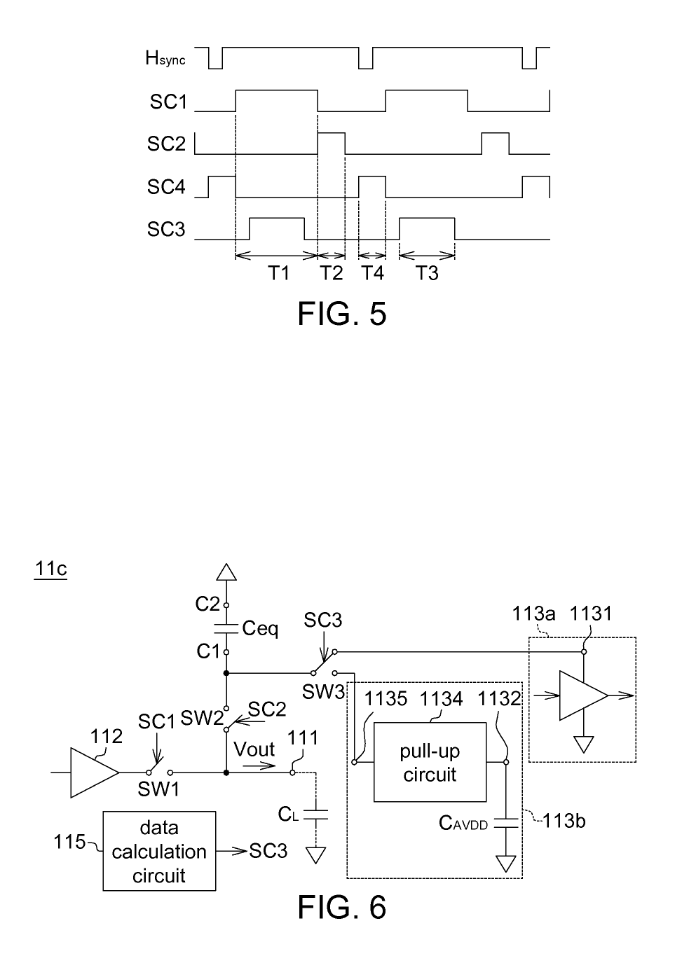

FIG. 4 shows a schematic diagram of a source driver according to a second embodiment. FIG. 5 shows a timing diagram of a horizontal scan input signal and switch control signals according to the second embodiment. Referring to FIGS. 2 and 4, main difference of the second embodiment from the first embodiment is that, a source driver 11b further includes a bias end 114 and a fourth switch SW4, and a power supply circuit 113b is a charge pump. The bias end 114 is maintained at a bias level greater than the ground level. The power supply circuit 113b includes a pull-up circuit 1134, an output capacitor C_{AVDD}, a voltage input end 1135 and a voltage output end 1132. The pull-up circuit 1134 and the output capacitor C_{AVDD} are coupled to the voltage output end 1132. The pull-up circuit 1132 receives a voltage via the voltage input end 1135, steps up the voltage, and outputs the stepped-up voltage via the voltage output end 1132.

The switch SW1 electrically connects the buffer amplifier 112 to the output pin 111 in a charge period T1. At this point, a pixel voltage Vout outputted by the buffer amplifier 112 is outputted via the switch SW1, the output pin 111 and the data line 13 to the pixel 15. The second switch SW2 then electrically connects the first end C1 of the recycle capacitor Ceq to the output pin 111 in a recollection period T2 to recollect charge of the recycle capacitor Ceq. Next, the fourth switch SW4 electrically connects the second end C2 of the recycle capacitor Ceq to the bias end 1132 in a step-up period T4 to pull up the reference voltage from the ground level to a bias level Vc. The step-up level T4 is between the recollection period T2 and the reuse period T3. The third switch SW3 then electrically connects the first end C1 of the recycle capacitor Ceq to the voltage output end 1132 of the power supply circuit 113b in the reuse period T3. Since the level of the first end C1 is pulled up in the step-up period T4, the recycle capacitor Ceq is able to provide a stepped-up voltage to the voltage output end 1132 and the output capacitor C_{AVDD} in the subsequent reuse period T3.

### Third Embodiment

FIG. 6 shows a schematic diagram of a source driver according to a third embodiment. Referring to FIGS. 2 and 6, a main difference of the third embodiment from the first embodiment is that, a source driver 11c further includes a data calculation circuit 115, and the power supply circuit 113a and the power supply circuit 113b are respectively a voltage regulator and a charge pump. The data calculation circuit 115 analyzes an image to be displayed to determine a recycled charge proportion, and outputs the switch control signal SC3 according to the recycled charge proportion. The third switch SW3 electrically connects the first end C1 to the power supply end 1131 of the power regulator or the voltage input end 1135 of the charge pump in the reuse period T3 according to the switch control signal SC3.

When the recycled charge proportion is low, the third switch electrically connects the first end C1 of the recycle capacitor Ceq to the power supply end 1131 of the voltage regulator in the reuse period T3 according to the switch control signal SC3. Conversely, when the recycled charge proportion is high, the third switch SW3 electrically connects the first end C1 of the recycle capacitor Ceq to the voltage input end 1135 of the charge pump in the reuse period T3 according to the switch control signal SC3.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A source driver, for driving a data line, comprising:
an output pin, coupled to the data line;
a buffer amplifier;
a first switch, for electrically connecting the buffer amplifier to the output pin in a charge period;
a recycle capacitor;
a second switch, coupled to the recycle capacitor, for electrically connecting the recycle capacitor to the output pin in a recollection period, the recollection period being after the charge period;
a power supply circuit; and
a third switch, for electrically connecting the recycle capacitor to the power supply circuit in a reuse period, the reuse period being after the recollection period.

2. The source driver according to claim 1, wherein the power supply circuit is a voltage regulator, and the third switch electrically connects the recycle capacitor to a power supply end of the voltage regulator in the reuse period.

3. The source driver according to claim 1, further comprising a bias end and a fourth switch; wherein, the power supply circuit is a charge pump; the charge pump comprises a pull-up circuit, an output capacitor and a voltage output end; the pull-up circuit and the output capacitor are coupled to the voltage output end; the fourth switch electrically connects the recycle capacitor to the bias end in a step-up period to pull up a reference voltage from a first level to a second level; the step-up period is between the recollection period and the reuse period.

4. The source driver according to claim 3, wherein the third switch electrically connects the recycle capacitor to the output capacitor in the reuse period, and the step-up period is between the recollection period and the reuse period.

5. The source driver according to claim 1, wherein the power supply circuit comprises a voltage regulator and a charge pump; and the third switch electrically connects the recycle capacitor to the voltage regulator or the charge pump in the reuse period.

6. The source driver according to claim 1, further comprising:
a data calculation circuit, for analyzing an image to be displayed to determine a recycled charge proportion, and outputs a switch control signal according to the recycled charge proportion;
wherein, the third switch electrically connects the recycle capacitor to the voltage regulator or the charge pump in the reuse period according to the switch control signal.

7. The source driver according to claim 1, wherein the recycle capacitor comprises a first end and a second end, the second end receives a reference voltage, and the third switch electrically connects the first end to the power supply circuit in the reuse period.

8. The source driver according to claim 7, wherein the power supply circuit is a voltage regulator, and the third switch electrically connects the first end to a power supply end of the voltage regulator in the reuse period.

9. The source driver according to claim 8, further comprising a bias end and a fourth switch; the power supply circuit is a charge pump; the charge pump comprises a pull-up circuit, an output capacitor and a voltage output end; the pull-up circuit and the output capacitor are coupled to the voltage output end; the fourth switch electrically connects the second end to the bias end in a step-up period to pull-up the reference voltage from a first level to a second level; the step-up period is between the recollection period and the reuse period.

10. The source driver according to claim 9, wherein the third switch electrically connects the first end to the output pin in the reuse period, and the step-up period is between the recollection period and the reuse period.

11. The source driver according to claim 7, wherein the power supply circuit comprises a voltage regulator and a charge pump; and the third switch electrically connects the first end to a power supply end of the voltage regulator or a voltage input end of the charge pump in the reuse period.

12. The source driver according to claim 7, further comprising:
a data calculation circuit, for analyzing an image to be displayed to determine a recycled charge proportion, and outputs a switch control signal according to the recycled charge proportion;
wherein, the third switch electrically connects the first end to a power supply end of the voltage regulator or a voltage input end of the charge pump in the reuse period according to the switch control signal.
